(19) United States
(12) Patent Application Publication
(10) Pub. No.: US 2025/0076946 A1
(43) Pub. Date: Mar. 6, 2025

(54) POWER LOSS PROTECTION POWER MANAGEMENT DEVICE AND STORAGE DEVICE

(71) Applicant: SAMSUNG ELECTRONICS CO., LTD., Suwon-si (KR)

(72) Inventors: Changhae YEOM, Suwon-si (KR); Daesung CHEON, Suwon-si (KR); Kwangseok GO, Suwon-si (KR); Minsung KIL, Suwon-si (KR)

(73) Assignee: SAMSUNG ELECTRONICS CO., LTD., Suwon-si (KR)

(21) Appl. No.: 18/653,403

(22) Filed: May 2, 2024

(30) Foreign Application Priority Data
Sep. 5, 2023 (KR) 10-2023-0117631

(51) Int. Cl. G06F 1/26; G06F 1/30

(52) U.S. Cl. CPC G06F 1/263; G06F 1/30

(57) ABSTRACT

A storage device is provided. The storage device includes: a memory controller configured to identify an operating state of the storage device based on a request signal provided by a host; an auxiliary power supply configured to provide an internal supply voltage; and a power loss protection (PLP) power manager configured to: generate a PLP charging voltage based on an external supply voltage; provide the PLP charging voltage to charge the auxiliary power supply until the PLP charging voltage reaches a first voltage level and discharge the auxiliary power supply until the PLP charging voltage reaches a second voltage level, in a normal state; and provide the PLP charging voltage to charge the auxiliary power supply until the PLP charging voltage reaches a third voltage level and discharge the auxiliary power supply until the PLP charging voltage to a fourth voltage level, in an idle state.

### CROSS-REFERENCE TO RELATED APPLICATION

This application claims priority to Korean Patent Application No. 10-2023-0117631, filed on Sep. 5, 2023, in the Korean Intellectual Property Office, the disclosure of which is incorporated by reference herein in its entirety.

### BACKGROUND

The present disclosure relates to an electronic device, and more particularly, to a power loss protection (PLP) power management device and a storage device.

Semiconductor memory may be classified into volatile memory such as dynamic random access memory (DRAM) and static RAM (SRAM), and nonvolatile memory such as electrically erasable programmable read-only memory (EEPROM), ferroelecric RAM (FRAM), phase-change RAM (PRAM), magnetoresistive RAM (MRAM), and flash memory. Volatile memory loses stored data when power supplied thereto is cut off, while nonvolatile memory preserves stored data even when power supplied thereto is cut off.

A memory system including a memory controller, a volatile memory, and a nonvolatile memory may operate using external power (i.e., from a source outside of the memory system). A sudden power-off event, in which power is suddenly cut off while the memory system is operating, may occur. In this case, data temporarily stored in the volatile memory may be lost, or the operation of a memory controller and/or non-volatile memory (e.g., an erase operation, writing operation, etc.) may not be completed. In this case, the memory system may complete the operation being performed by using an auxiliary power supply and back up the data. Operations of completing operations in progress and backing up data using an auxiliary power supply may be referred to as PLP operations. While an operation of charging an auxiliary power source with electrical energy required to perform the PLP operation is performed, predetermined power may be consumed. Furthermore, as the applications and demands of memory systems increase, the storage capacity of a memory system (e.g., the storage capacity of nonvolatile memory) continues to increase, and accordingly, the power consumed to charge electrical energy to the auxiliary power source also increases.

### SUMMARY

One or more example embodiments provide power loss protection (PLP) power management devices and storage devices to reduce the power consumed while charging an auxiliary power source with electrical energy required to perform PLP operations.

According to an aspect of an example embodiment, a storage device includes: a memory controller configured to identify an operating state of the storage device based on an input/output request signal provided by a host; an auxiliary power supply configured to provide an internal supply voltage in a Sudden Power Off (SPO) event; and a PLP power manager configured to: generate a PLP charging voltage based on an external supply voltage; provide the PLP charging voltage to charge the auxiliary power supply until the PLP charging voltage reaches a first voltage level and discharge the auxiliary power supply until the PLP charging voltage reaches a second voltage level, in a normal state of the storage device; and provide the PLP charging voltage to charge the auxiliary power supply until the PLP charging voltage reaches a third voltage level and discharge the auxiliary power supply until the PLP charging voltage to a fourth voltage level, in an idle state of the storage device.

According to another aspect of an example embodiment, a storage device includes: a memory controller configured to identify an operating state of the storage device based on an input/output request signal provided by a host, an auxiliary power supply configured to provide an internal supply voltage in an SPO event; and a PLP power manager configured to: generate a PLP charging voltage based on an external supply voltage; provide the PLP charging voltage to charge the auxiliary power supply during a first charge time and discharge the auxiliary power supply a first discharge time, in a normal state of the storage device; and provide the PLP charging voltage to charge the auxiliary power supply during a second charge time and discharge the auxiliary power supply during a second discharge time, in an idle state of the storage device.

According to another aspect of an example embodiment, a PLP power management device includes: a voltage converter configured to convert an external supply voltage to a PLP voltage based on a reference voltage and a feedback voltage, and provide the PLP voltage to a PLP capacitor via a first node; a feedback voltage divider configured to provide the feedback voltage to the voltage converter based on the PLP voltage; a discharge load resistor connected in parallel with the PLP capacitor; and a PLP voltage regulator configured to perform any one or any combination of a first operation to change the feedback voltage, a second operation to block a discharge path between the PLP capacitor and the discharge load resistor, and a third operation to change the reference voltage.

### BRIEF DESCRIPTION OF DRAWINGS

The above and other aspects will be more apparent from the following description of example embodiments, taken in conjunction with the accompanying drawings, in which:

FIG. 1 is a block diagram of a storage device according to an example embodiment;

FIG. 2 is a diagram illustrating a PLP power manager according to an example embodiment;

FIG. 3 is a graph illustrating a PLP voltage of the PLP power manager of FIG. 2;

FIG. 4 is a diagram illustrating a PLP power manager according to an example embodiment;

FIG. 5 is a graph illustrating a PLP voltage of the PLP power manager of FIG. 4;

FIG. 6 is a diagram illustrating a PLP power manager according to an example embodiment;

FIGS. 7A, 7B, and 7C are diagrams illustrating PLP power managers according to example embodiments;

FIG. 8 is a circuit diagram of an auxiliary power supply according to an example embodiment;

FIG. 9 is a diagram for explaining discharge paths according to an example embodiment;

FIG. 10 is a block diagram of a storage system according to an example embodiment;

FIG. 11 is a flowchart illustrating a method of operating a PLP power management device, according to an example embodiment;

FIGS. 12, 13, and 14 are flowcharts for describing operations S40 and S50 of FIG. 11 according to an example embodiment; and

FIG. 15 is a block diagram illustrating a solid state drive (SSD) system according to an example embodiment.

### DETAILED DESCRIPTION

Hereinafter, example embodiments will be described in detail with reference to the accompanying drawings. Embodiments described herein are example embodiments, and thus, the present disclosure is not limited thereto, and may be realized in various other forms. Each example embodiment provided in the following description is not excluded from being associated with one or more features of another example or another example embodiment also provided herein or not provided herein but consistent with the present disclosure. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

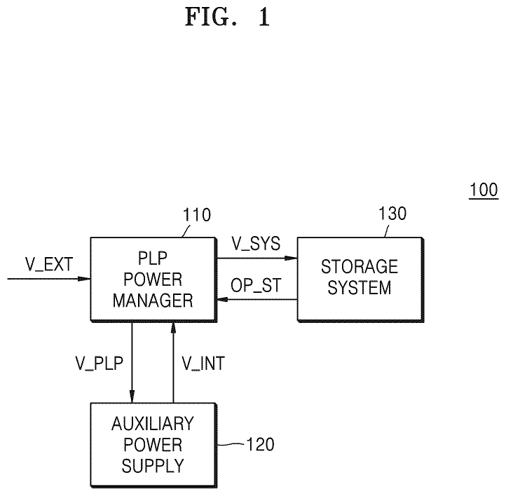

FIG. 1 is a block diagram of a storage device 100 according to an example embodiment.

Referring to FIG. 1, the storage device 100 according to some example embodiments may be implemented as a solid state drive (SSD). However, example embodiments are not limited thereto. In other example embodiments, the storage device 100 may be implemented by any of a variety of storage devices, such as a multimedia card (MMC), an embedded MMC (eMMC), a Reduced Size MMC (RS-MMC), a micro-MMC type multimedia card, a Secure Digital (SD) card, a mini-SD card, a micro-SD type SD card, a Universal Serial Bus (USB) storage device, a Universal Flash Storage (UFS) device, a Personal Computer Memory Card International Association (PCMCIA) card type storage device, a Peripheral Component InterConnection (PCI) card type storage device, a PCI-express (PCI-E) card type storage device, a Compact Flash (CF) card, a smart media card, and a memory stick.

The storage device 100 may include a power loss protection (PLP) power manager 110, an auxiliary power supply 120, and a storage system 130. The storage device 100 may receive an external supply voltage V_EXT from an external power source. The external power source may be, for example, a voltage source but is not limited thereto. The auxiliary power supply 120 may include, for example, one or more capacitors.

The PLP power manager 110 may monitor the voltage level of the external supply voltage V_EXT. The PLP power manager 110 may monitor the voltage level of an internal system voltage V_SYS. When the external supply voltage V_EXT is normally supplied to the PLP power manager 110, the PLP power manager 110 may control the external supply voltage V_EXT to be provided to the storage system 130 as main power. That is, the PLP power manager 110 may supply the system voltage V_SYS to the storage system 130 based on the external supply voltage V_EXT. In this case, the PLP power manager 110 may block the backup electrical energy (e.g., PLP charging voltage) charged on the auxiliary power supply 120 from being output as auxiliary power to the storage system 130. The external supply voltage V_EXT being normally supplied to the PLP power manager 110, for example, may indicate that the voltage level of the external supply voltage V_EXT is higher than or equal to an initially set allowable voltage level.

In addition, the external supply voltage V_EXT may not be normally supplied. For example, in a Sudden Power Off (SPO) situation where power is suddenly cut off while the storage device 100 is operating, the external supply voltage V_EXT may not be normally supplied to the PLP power manager 110. In this case, it is necessary to complete operations in processing, such as storing data received by the storage device 100 and/or data temporarily stored in the storage device 100. As such, when an SPO occurs, the operation to process incomplete operations or prevent data loss in the storage device 100 may be referred to as a PLP operation. To perform a PLP operation, it is necessary to have an internal power source that provides internal power inside the storage device 100. The internal power source may be charged by a voltage. To this end, the PLP power manager 110 may charge electrical energy to the auxiliary power supply 120 based on the external supply voltage V_EXT while the external power supply voltage V_EXT is normally supplied (i.e., before an SPO occurs). In this case, the PLP power manager 110 may repeatedly control operations that fully charge more electrical energy than a minimum electrical energy required for the PLP operation to the auxiliary power supply 120, and partially discharge the backup electrical energy of the auxiliary power supply 120. The PLP power manager 110 may monitor the auxiliary power supply 120 during the repeated charge and discharge operations to identify abnormalities such as deterioration of the auxiliary power supply 120. In order to sufficiently deliver electrical energy that exceeds the minimum electrical energy required for the PLP operation to the auxiliary power supply 120, the PLP power manager 110 may provide a PLP voltage V_PLP to the auxiliary power supply 120. When the PLP power manager 110 monitors an abnormality such as deterioration of the auxiliary power supply 120, the PLP power manager 110 may consume a predetermined amount of power (or electrical energy).

When an SPO occurs, if the external supply voltage V_EXT is not normally supplied to the PLP power manager 110, the PLP power manager 110 may supply the system voltage V_SYS to the storage system 130 based on the internal supply voltage V_INT provided from the auxiliary power supply 120. The system voltage V_SYS may be output using the internal supply voltage V_INT through the PLP power manager 110. In this case, the internal supply voltage V_INT may be a PLP charging voltage.

In some example embodiments, the PLP power manager 110 may be implemented as a PLP integrated circuit (PLP IC) but is not limited thereto. In other example embodiments, the PLP power manager 110 and the auxiliary power supply 120 may be included in a device (e.g., a power supply device) for supplying system power to the storage system 130. The PLP power manager 110 may be referred to as a PLP power management device.

The auxiliary power supply 120 may store backup electrical energy using the PLP voltage V_PLP. The voltage charged in the auxiliary power supply 120 may be referred to as a PLP charging voltage. The PLP charging voltage may be stored in one or more capacitors of the auxiliary power supply 120. When the external supply voltage V_EXT is supplied normally to the PLP power manager 110, the auxiliary power supply 120 stores the second electrical energy that is greater than or equal to the minimum first electrical energy required for the PLP operation, using the PLP voltage V_PLP, and the auxiliary power supply 120 discharges some of the second electrical energy, thereby storing at least the first electrical energy (the minimum energy required for the PLP operation). These operations may be repeated. A first voltage level of the PLP charging voltage corresponding to the first electrical energy may be lower than a second voltage level of the PLP charging voltage corresponding to the second electrical energy. When an SPO occurs, the auxiliary power supply 120 may supply the PLP charging voltage corresponding to the electrical energy stored in the auxiliary power supply 120 as the internal supply voltage V_INT.

The storage system 130 may operate using the system voltage V_SYS. For example, when the external supply voltage V_EXT is normally provided to the PLP power manager 110, the system voltage V_SYS may be generated based on the external supply voltage V_EXT. When the external supply voltage V_EXT is not normally provided (e.g., when an SPO event occurs) to the PLP power manager 110, the system voltage V_SYS may be generated based on the internal supply voltage V_INT. In this case, the storage system 130 may complete an operation in progress in the storage system 130 or perform a data backup (or data dump).

The storage system 130 may determine an operation state of the storage device 100 based on an input/output request signal (or I/O request signal) provided from the outside. The operating state of the storage device 100 may include, for example, a normal state and an idle state. The storage system 130 may provide an operating state signal OP_ST to the PLP power manager 110, the operating state signal OP_ST indicating the operation state of the storage device 100. The normal state may be a state in which the storage device 100 performs an operation according to an input/output request signal. The normal state may be referred to as a normal operation state. The idle state may be a state in which the storage device 100 waits to receive an input/output request signal, or performs an internal operation such as wear-leveling or garbage collection. The power consumed in the idle state may be less than the power consumed by the storage device 100 in the normal state. In addition, because the input/output request signal is not provided from a host in the idle state, when an SPO occurs, the operation of performing data dump in the storage device 100 may be omitted or reduced. Therefore, as the PLP operation is performed when an SPO occurs in the idle state, the power consumed may be less than the power consumed as the PLP operation is performed when an SPO occurs in the normal state. Accordingly, the electrical energy stored in the auxiliary power supply 120, that is, the minimum backup electrical energy required for the PLP operation, may be less in the idle state than in the normal state.

When the storage capacity of the storage device 100 increases, more electrical energy and power required for the storage device 100 to operate are required. Thus, as the storage capacity of the storage device 100 increases, the electrical energy consumed by the storage device 100 also increases. In this case, power required by the standard (e.g., Open Compute Project (OCP) Datacenter NVMe SSD Specification 2.0) associated with the storage device 100 (e.g., the idle state power in OCP Datacenter NVMe SSD Specification 2.0 (hereinafter, PWR-6)) may not be met (e.g., PWR-6 is less than 5 [W] in OCP Datacenter NVMe SSD Specification 2.0). Therefore, it is necessary to adjust the predetermined power consumed when the PLP power manager 110 monitors the abnormality of the auxiliary power supply 120 according to the operation state of the storage device 100. For example, there is a need to reduce the power consumed when the PLP power manager 110 monitors the abnormalities of the auxiliary power supply 120 in the idle state.

In some example embodiments, the PLP power manager 110 may receive an operating state signal OP_ST from the storage system 130. The PLP power manager 110 may monitor the abnormalities of the auxiliary power supply 120 in any one of a first PLP power management mode and a second PLP power management mode, depending on the operating state of the storage device 100. For example, in the normal state of the storage device 100, the PLP power manager 110 executes a first monitoring mode, and charges and discharges the PLP charging voltage of the auxiliary power supply 120 based on the external supply voltage V_EXT, to thereby consume first power. In the idle state of the storage device 100, the PLP power manager 110 executes a second monitoring mode, and charges and discharges the PLP charging voltage of the auxiliary power supply 120 based on the external supply voltage V_EXT, to thereby consume second power. The second power may be less than the first power.

In some configurations, the average amount of external power P_{ext_avg} may be calculated according to [Equation 1] below.

$${P}_{ext \_ avg} = {V}_{in} \cdot {I}_{in} \cdot \frac{{Time}_{charge}}{( {Time}_{charge} + {Time}_{discharge} )} \qquad [ Equation 1 ]$$

Here, Vᵢₙ may be an average value of the external supply voltage V_EXT, Iᵢₙ may be an average value of the external supply current, Time_{charge} may be a charge time of the PLP charging voltage, and Time_{discharge} may be a discharge time of the PLP charging voltage. In Equation 1, external supply current may be an average value of current consumed when charging.

The charge time Time_{charge} may be calculated according to the following Equation 2.

$${Time}_{charge} = \frac{{C}_{PLP} \cdot Δ V}{{I}_{{cap}_{charge}}} = \frac{{C}_{PLP} \cdot Δ V}{{V}_{in} \cdot {I}_{in} \cdot {Effi}_{DCDC {/}_{{V}_{cap}} -} {V}_{cap {/}_{{R}_{discharge}}}} \qquad [ Equation 2 ]$$

Here, C_{PLP} is a capacitance of a PLP capacitor included in the auxiliary power supply 120, ΔV is a voltage level difference, I_{cap}_{_{charge}} is a current of the PLP capacitor, Effi_{DCDC} is the power efficiency of a DC/DC converter, V_{cap} is a voltage of the PLP capacitor, and R_{discharge} is a resistance of a discharge load resistor.

The discharge time Time_{discharge} may be calculated according to the following Equation 3.

$${Time}_{discharge} = {Time}_{discharge} \cdot {C}_{PLP} \cdot ln ( V 2 / V 1 ) \qquad [ Equation 3 ]$$

Here, V1 is a first voltage level and V2 is a second voltage level.

Referring to [Equation 1], [Equation 2], and [Equation 3] described above, the PLP power manager 110 may reduce power P_{ext_avg} in an idle state by reducing the charge time Time_{charge}. The PLP power manager 110 may reduce power P_{ext_avg} in an idle state by increasing the discharge time Time_{discharge}.

According to an example embodiment, the overall power (or overall electrical energy) consumed by the storage device 100 may be reduced by reducing the power consumed to monitor whether the auxiliary power supply 120 is abnormal while the storage device 100 is idle. In addition, resources may be designed to further increase the storage space of the storage device 100. In addition, storage devices 100 required by the standard (e.g., OCP Datacenter NVMe SSD Specification 2.0) may be provided.

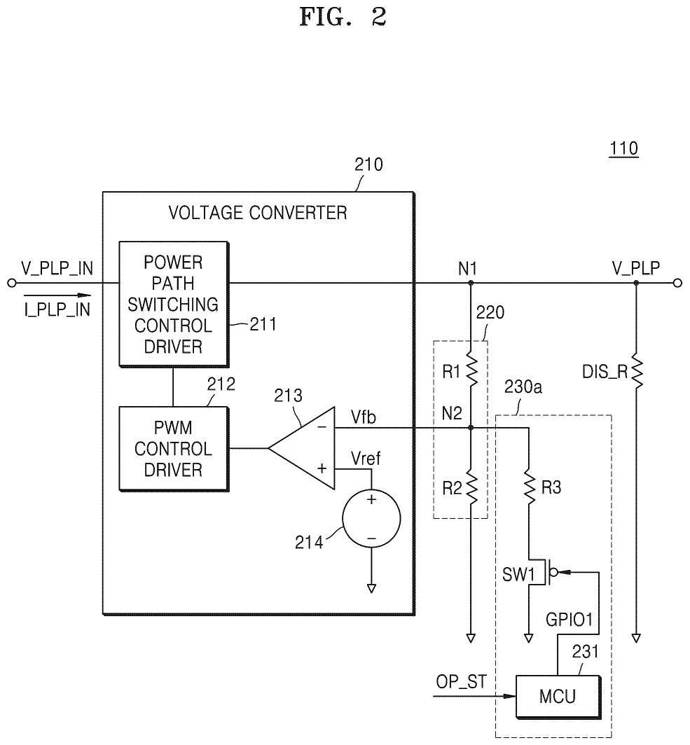

FIG. 2 is a diagram illustrating a PLP power manager 110 according to an example embodiment.

Referring to FIG. 2, the PLP power manager 110 may include a voltage converter 210, a feedback voltage divider 220, a PLP voltage regulator 230a, and a discharge load resistor DIS_R.

The voltage converter 210 may change an external supply voltage V_PLP_IN to a PLP voltage V_PLP based on a reference voltage Vref and a feedback voltage Vfb. The voltage converter 210 may output the PLP voltage V_PLP to a first node N1. The voltage converter 210 may adjust the PLP voltage V_PLP so that the voltage level of the reference voltage Vref and the voltage level of the feedback voltage Vfb are the same. The voltage level of the reference voltage Vref of FIG. 2 may be constant, and the voltage level of the feedback voltage Vfb may vary. The external supply voltage V_PLP_IN may correspond to the external supply voltage V_EXT of FIG. 1. For example, the external supply voltage V_PLP_IN may be a part of the external supply voltage V_EXT of FIG. 1. For example, the voltage level of the external supply voltage V_PLP_IN may be the same as the voltage level of the external supply voltage V_EXT of FIG. 1. In some example embodiments, the external supply current I_PLP_IN may be a current of a square wave (or square wave). Accordingly, the external supply voltage V_PLP_IN may also be a voltage of a square wave. The voltage converter 210 according to some example embodiments may include a power path switching control driver 211, a pulse width modulation (PWM) control driver 212, an amplifier 213, and a reference voltage source 214 as a DC/DC converter. In an example embodiment, the power path switching control driver 211 and the PWM control driver 212 may be implemented as separate circuits as shown in FIG. 2 but are not limited thereto, and in another example embodiment, the power path switching control driver 211 and the PWM control driver 212 may each be implemented as a DC/DC converter power switching circuit. Hereinafter, example embodiments will be described based on a DC/DC converter power switching circuit including the power path switching control driver 211 and the PWM control driver 212. The DC/DC converter power switching circuit may rectify the external supply voltage V_PLP_IN to a voltage of a boosting or buck and output the rectified PLP voltage V_PLP. The DC/DC converter power switching circuit may include various active elements (e.g., switches such as transistors), passive elements (e.g., inductors, capacitors, etc.), and gate-drivers (e.g., buffers, inverters, etc.) for controlling active elements. The DC/DC converter power switching circuit may operate so that (i.e., to control) the voltage level of the reference voltage Vref and the voltage level of the feedback voltage Vfb are equal to each other. The feedback voltage Vfb may be input to a first terminal of the amplifier 213, the first terminal of the amplifier 213 may be connected to a second node N2, and the reference voltage Vref may be input at a second terminal of the amplifier 213. The amplifier 213 may amplify the level difference between the feedback voltage Vfb and the reference voltage Vref. The reference voltage source 214 may provide the reference voltage Vref. A first terminal of the reference voltage source 214 may be coupled to the second terminal of the amplifier 213, and a second terminal of the reference voltage source 214 may be connected to the ground.

The feedback voltage divider 220 may provide the feedback voltage Vfb to the voltage converter 210 based on the PLP voltage V_PLP. In some example embodiments, the feedback voltage divider 220 may include a first resistor R1 and a second resistor R2. The first resistor R1 may be arranged and/or connected between the first node N1 and the second node N2. For example, a first terminal of the first resistor R1 may be connected to the first node N1, and a second terminal of the first resistor R1 may be connected to the second node N2. The feedback voltage Vfb may be generated at the second node N2. The second resistor R2 may be arranged and/or connected between the second node N2 and the ground. For example, a first terminal of the second resistor R2 may be connected to the second node N2, and a second terminal of the second resistor R2 may be connected to the ground.

The PLP voltage regulator 230a may perform a first operation of changing a feedback voltage in an idle state of the storage device 100. In some example embodiments, the PLP voltage regulator 230a may include a third resistor R3, a first switch SW1, and a controller 231. The first switch SW1 may be connected in series with the third resistor R3 between the second node N2 and the ground. For example, a first terminal of the third resistor R3 may be connected to the second node N2, and a second terminal of the third resistor R3 may be connected to a first electrode of the first switch SW1. A second electrode of the first switch SW1 may be connected to the ground. The first switch SW1 may operate in response to a first control signal GPIO1.

In an example embodiment, a resistance of the second resistor R2 may be greater than a composite resistance of the second resistor R2 and the third resistor R3 (i.e., a total circuit resistance of the second resistor R2 connected in parallel with the third resistor R3). The first switch SW1 may be turned on in a normal state to electrically connect the second node N2, the third resistor R3, and the ground. For example, the first control signal GPIO1 may be input to a gate electrode of the first switch SW1. When the first control signal GPIO1 having an activation logic level or a turn-on logic level for turning on the first switch SW1 is applied to the gate electrode of the first switch SW1, the first switch SW1 is turned on in response to the first control signal GPIO1 and the third resistor R3 and the ground may be electrically connected. When the third resistor R3 and the ground are electrically connected as the first switch SW1 is turned on, the second resistor R2 and the third resistor R3 may be connected in parallel between the second node N2 and the ground. In this case, a composite resistance between the second resistor R2 and the third resistor R3 may be set. The resistance of the composite resistance may be less than the resistance of the second resistor R2. The voltage level of the feedback voltage Vfb may be changed due to a change in resistance, and the PLP voltage V_PLP may be increased. The first switch SW1 may electrically open the second node N2, the third resistor R3, and the ground in the idle state. For example, when the first control signal GPIO1 having an inactive logic level or a turn-off logic level for turning off the first switch SW1 is applied to the gate electrode of the first switch SW1 (when the activation logic level of the first control signal GPIO1 is asserted low), the first switch SW1 may be turned off in response to the first control signal GPIO1 and the third resistor R3 and the ground may be electrically opened. In this case, the second resistor R2 is set, and the resistance of the lower end of the feedback voltage Vfb increases. Accordingly, the PLP voltage V_PLP may be reduced. As the PLP voltage V_PLP decreases, the PLP charging voltage of the auxiliary power supply 120 of FIG. 1 may also decrease. In some example embodiments, the first switch SW1 may be implemented as a p-type transistor. However, example embodiments are not limited thereto, and in other example embodiments, the first switch SW1 may be implemented as an n-type transistor. The controller 231 may output the first control signal GPIO1 based on the operation state signal OP_ST. For example, when an operating state is indicated as a normal state by the operating state signal OP_ST, the controller 231 may output the first control signal GPIO1 having an activation logic level or a turn-on logic level for turning on the first switch SW1. For example, when the operation state is indicated as an idle state by the operation state signal OP_ST, the controller 231 may output the first control signal GPIO1 having an inactive logic level or a turn-off logic level. However, example embodiments are not limited thereto. According to an example embodiment, the controller 231 may output the first control signal GPIO1 while the storage system 130 is in the idle state. For example, when the operation state of the storage system 130 is the idle state, the controller 231 may output the first control signal GPIO1, and when the operation state of the storage system 130 is the normal state, the controller 231 may not output the first control signal GPIO1.

The controller 231 may be implemented as a micro controller unit (MCU) as shown in FIG. 2 but is not limited thereto. The controller 231 according to some example embodiments may be included in the PLP voltage regulator 230a, but the controller 231 according to other example embodiments may be included in the storage system 130 (e.g., a memory controller) of FIG. 1.

The discharge load resistor DIS_R may be arranged and/or connected between the first node N1 and ground. For example, a first terminal of the discharge load resistor DIS_R may be connected to the first node N1, and a second terminal of the discharge load resistor DIS_R may be connected to the ground. A discharge path may be formed by the discharge load resistor DIS_R and the auxiliary power supply 120 of FIG. 1.

According to an example embodiment consistent with FIG. 2, the power consumed to monitor whether the auxiliary power supply 120 is abnormal in an idle state may be reduced by changing the resistance of a composite resistor placed at a lower end of the feedback voltage divider 220 in the idle state of the storage device 100.

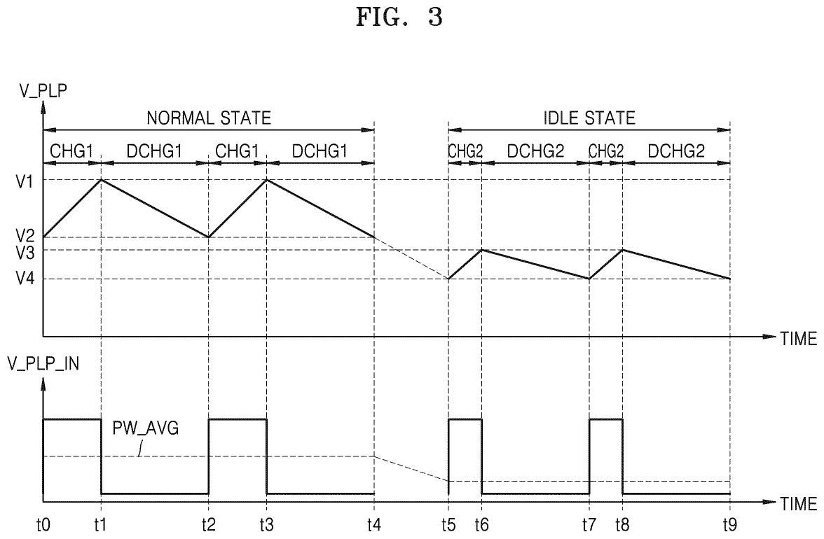

FIG. 3 is a graph illustrating a PLP voltage of the PLP power manager 110 of FIG. 2.

Referring to FIGS. 1, 2, and 3, the PLP power manager 110 may control the PLP charging voltage (e.g., a PLP voltage V_PLP) to be charged to a first voltage level V1 and discharged from the first voltage level V1 to a second voltage level V2. The first voltage level V1 may be a voltage level required to monitor an abnormality such as deterioration of the auxiliary power supply 120 in the normal state. The second voltage level V2 may correspond to the minimum voltage level of the PLP charging voltage required to perform a PLP operation in both the idle state and the normal state. The first voltage level V1 may be higher than the second voltage level V2. In the normal state, when the waveform of the external supply current I_PLP_IN is a square wave, the waveform of the external supply power may also be a square wave. While the external supply voltage V_PLP_IN is supplied from time t0, the voltage level of the PLP voltage V_PLP may increase. At time t1, the voltage level of the PLP voltage V_PLP may reach the first voltage level V1. In this case, a first charge time CHG1 in the normal state may range from time t0 to time t1. After time t1, charging of the PLP voltage V_PLP may be blocked. The voltage level of the PLP voltage V_PLP may decrease. At time t2, the voltage level of the PLP voltage V_PLP may reach the second voltage level V2. The first discharge time DCHG1 in the normal state may range from time t1 to time t2. During the first charge time CHG1 corresponding to an interval of time between the time t2 to the time t3 and the first discharge time DCHG1 corresponding to an interval of time between the time t3 to the time t4, the voltage level of the PLP voltage V_PLP may increase from the second voltage level V2 to the first voltage level V1 and decrease from the first voltage level V1 to the second voltage level V2. In such a normal state, the charging/discharging operation of the PLP voltage V_PLP may be repeated under control of the PLP power manager 110.

After time t4, the operating state of the storage device 100 may change from a normal state to an idle state. The change may be indicated by the operating state signal OP_ST. The PLP power manager 110 may control a PLP charging voltage (e.g., a PLP voltage V_PLP) to be charged to a third voltage level V3 from a fourth voltage level V4 and discharged from the third voltage level V3 to the fourth voltage level V4. The fourth voltage level V4 may correspond to the minimum voltage level of the PLP charging voltage required to perform a PLP operation in an idle state. The third voltage level V3 may be a voltage level required to monitor an abnormality such as deterioration of the auxiliary power supply 120 in the idle state. The third voltage level V3 may be lower than the first voltage level V1. The third voltage level V3 may be lower than the second voltage level V2 but is not limited thereto, and unlike as shown in FIG. 3, the third voltage level V3 may be higher than the second voltage level V2. At time t5, the voltage level of the PLP voltage V_PLP may reach the fourth voltage level V4. While the external supply voltage V_PLP_IN is supplied after time t5, the voltage level of the PLP voltage V_PLP may increase. At time t6, the voltage level of the PLP voltage V_PLP may reach the third voltage level V3. In this case, the second charge time CHG2 in the idle state may be less (or shorter) than the first charge time CHG1. As the external supply voltage V_PLP_IN is cut off after time t6, the voltage level of the PLP voltage V_PLP may decrease. At time t7, the voltage level of the PLP voltage V_PLP may reach the fourth voltage level V4. The second discharge time DCHG2 in the idle state may be less than the first discharge time DCHG1 to have a very small difference or may be substantially similar to the first discharge time DCHG1. The first discharge time DCHG1 and the second discharge time DCHG2 may be ideally the same. The charging/discharging operation of the PLP voltage V_PLP may be repeated in the idle state under control of the PLP power manager 110.

In an example embodiment consistent with FIG. 3, charge time may be reduced by providing the auxiliary power supply 120 with a voltage level of the PLP voltage V_PLP at the third voltage level V3 lower than the first voltage level V1 in an idle state. Accordingly, the power consumed by the PLP power manager 110 may be reduced, for example, the average power PW_AVG according to the external supply current I_PLP_IN and the external supply voltage V_PLP_IN.

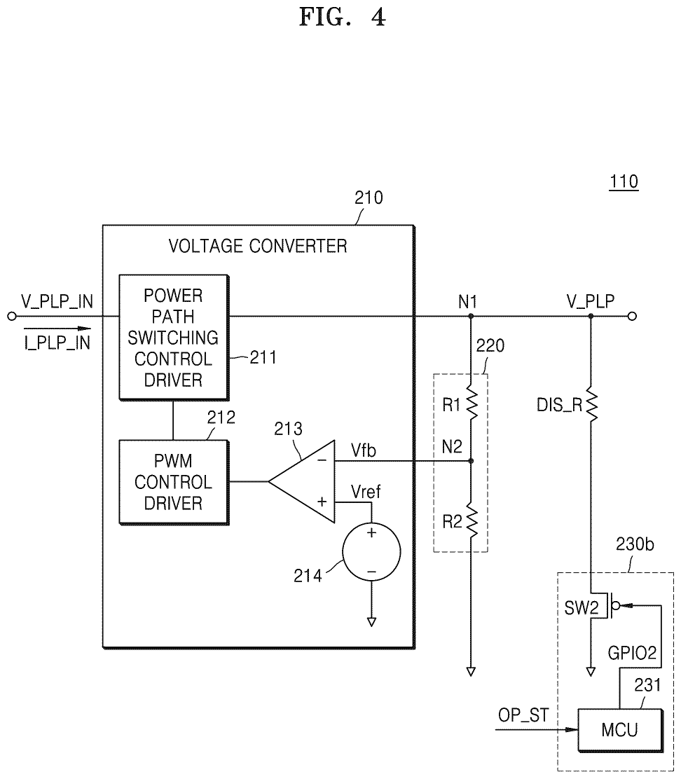

FIG. 4 is a diagram illustrating a PLP power manager 110 according to an example embodiment.

Referring to FIG. 4, the PLP power manager 110 may include a voltage converter 210, a feedback voltage divider 220, a PLP voltage regulator 230b, and a discharge load resistor DIS_R. The voltage converter 210 and the feedback voltage divider 220 are the same as those described above with reference to FIG. 2.

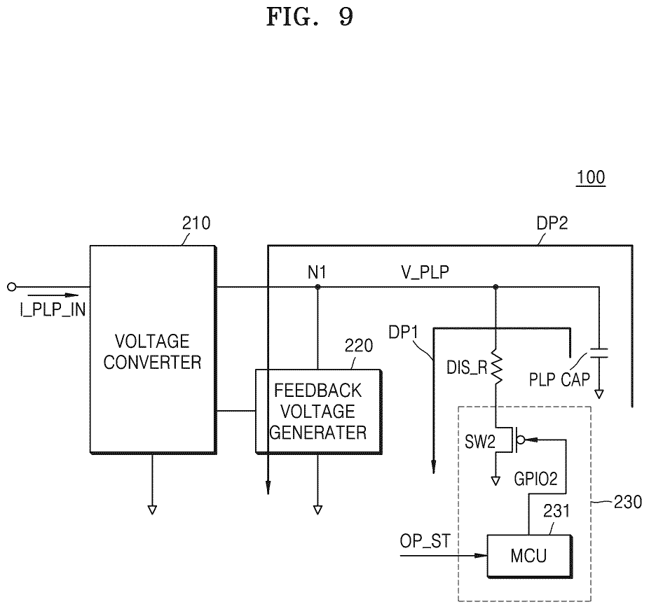

The PLP voltage regulator 230b may perform a second operation of blocking a discharge path between the auxiliary power supply 120 and the discharge load resistance DIS_R while the storage device 100 is in an idle state. The discharge path will be described later referring to FIG. 9.

In some example embodiments, the PLP voltage regulator 230b may include a second switch SW2 and a controller 231. The second switch SW2 may be arranged between the first node N1 and the ground. For example, the second switch SW2 may be connected in series with the discharge load resistor DIS_R between the first node N1 and the ground. For example, a first electrode of the second switch SW2 may be connected to a first terminal of the discharge load resistor DIS_R, and a second electrode of the second switch SW2 may be connected to the ground. The second switch SW2 may electrically connect the first node N1, the discharge load resistor DIS_R, and the ground in a normal state. The second switch SW2 may be turned off in the idle state. For example, a second control signal GPIO2 may be input to a gate electrode of the second switch SW2. When a second control signal GPIO2 having an inactive logic level or a turn-off logic level for turning off the second switch SW2 is applied to the gate electrode of the second switch SW2, the second switch SW2 is turned off in response to the second control signal GPIO2, and the electrical connection between the discharge load resistor DIS_R and the ground may be cut off. When the discharge load resistor DIS_R and the ground are electrically disconnected from each other, the discharge current may be reduced and the time (e.g., discharge time) required to discharge the PLP charging voltage may be increased. In some example embodiments, the second switch SW2 may be implemented as a p-type transistor. However, example embodiments are not limited thereto, and in other example embodiments, the second switch SW2 may be implemented as an n-type transistor. For example, when the operation state of the storage system 130 is indicated as an idle state by the operation state signal OP_ST, the controller 231 may output the second control signal GPIO2 having an inactive logic level or a turn-off logic level, and when the operation state of the storage system 130 is the normal state, the controller 231 may not output the first control signal GPIO1.

According to an example embodiment consistent with FIG. 4, the power consumed to monitor whether the auxiliary power supply 120 is abnormal in the idle state may be reduced by cutting off the electrical connection between the discharge load resistor DIS_R and the ground in the idle state of the storage device 100.

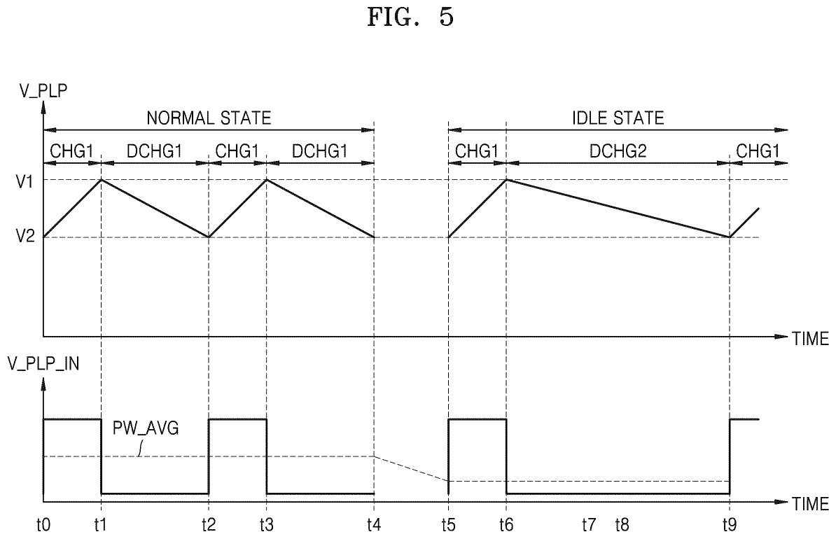

FIG. 5 is a graph illustrating a PLP voltage of the PLP power manager 110 of FIG. 4.

Referring to FIGS. 1, 4, and 5, the PLP power manager 110 may control a PLP charging voltage (e.g., a PLP voltage V_PLP) to be charged during a first charge time CHG1 and discharged during a first discharge time DCHG1. In this case, it is assumed that the voltage level of the PLP charging voltage (e.g., the PLP voltage V_PLP) is the first voltage level V1 when the first charge time CHG1 has elapsed, and the voltage level of the PLP charging voltage (e.g., the PLP voltage V_PLP) is the second voltage level V2 when the first discharge time DCHG1 has elapsed. In this case, the charging/discharging operation of the PLP voltage V_PLP, which is performed in a normal state, may be the same as described with reference to FIG. 3.

After time t4, the operating state of the storage device 100 may change from a normal state to an idle state. The change may be indicated by the operating state signal OP_ST. The PLP power manager 110 may control the PLP charging voltage (e.g., the PLP voltage V_PLP) to be charged during the first charge time CHG1and discharged during the second discharge time DCHG2, in an idle state. Even when the operating state of the storage device 100 changes from a normal state to an idle state, the range between the maximum voltage level (e.g., the first voltage level V1) and the minimum voltage level (e.g., the second voltage level V2) of the PLP charging voltage may be the same. Therefore, the charge time in each of the normal state and the idle state may be the same as the first charge time CHG1. However, because the discharge time increases as the discharge load resistor DIS_R and the ground are electrically disconnected in the idle state, the second discharge time DCHG2 may be greater (or longer) than the first discharge time DCHG1.

As shown in FIG. 5, the discharge time may be increased by interrupting the electrical connection between the discharge load resistor DIS_R and the ground in an idle state. Accordingly, the power consumed by the PLP power manager 110 may be reduced, for example, the average power PW_AVG according to the external supply current I_PLP_IN and the external supply voltage V_PLP_IN.

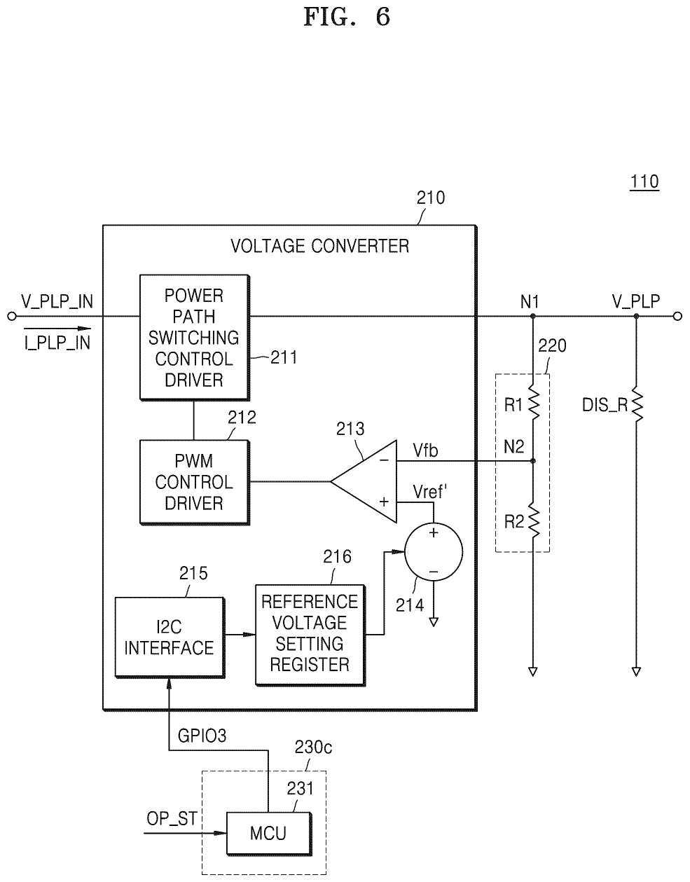

FIG. 6 is a diagram illustrating a PLP power manager 110 according to an example embodiment.

Referring to FIG. 6, the PLP power manager 110 may include a voltage converter 210, a feedback voltage divider 220, a PLP voltage regulator 230c, and a discharge load resistor DIS_R. The feedback voltage divider 220 is the same as described above with reference to FIG. 2.

The operation of the voltage converter 210 of FIG. 6 is the same as described above with reference to FIG. 2. However, the voltage level of the reference voltage Vref included in the voltage converter 210 of FIG. 6 may be changed. The reference voltage source 214 may provide the reference voltage Vref. In some example embodiments, the voltage converter 210 of FIG. 6 may further include an inter-integrated circuit (I2C) interface 215 and a reference voltage setting register 216. The I2C interface 215 may perform I2C communication with a controller 231. However, example embodiments are not limited thereto, and an interface that performs communication in a different way from I2C communication may be included in the voltage converter 210 of FIG. 6. The I2C interface 215 may transmit a third control signal GPIO3 received from the controller 231 to the reference voltage setting register 216. The reference voltage setting register 216 may reduce a voltage level of the reference voltage Vref in response to the third control signal GPIO3. For example, the reference voltage setting register 216 may set the reduced reference voltage Vref in response to the third control signal GPIO3. Accordingly, the reference voltage source 214 may provide the reduced reference voltage Vref to the amplifier 213. The voltage level of each of the PLP voltage V_PLP and the PLP charging voltage may be reduced by the reduced reference voltage Vref′, similarly to that illustrated in FIG. 3.

The PLP voltage controller 230c may perform a third operation of changing the reference voltage Vref in an idle state of the storage device 100. In some example embodiments, the PLP voltage regulator 230c may include the controller 231. The controller 231 may output the third control signal GPIO3 based on operation state signal OP_ST. The third control signal GPIO3 may be a signal for setting a voltage level of the reference voltage Vref. For example, when the operating state is a normal state by the operating state signal OP_ST, the third control signal GPIO3 may instruct to set the first voltage level. For example, when the operation state is idle due to the operation state signal OP_ST, the third control signal GPIO3 may instruct to set the second voltage level lower than the first voltage level.

As shown in FIG. 6, power consumed for monitoring whether the auxiliary power supply 120 is abnormal in an idle state may be reduced by changing a reference voltage Vref in an idle state of the storage device 100.

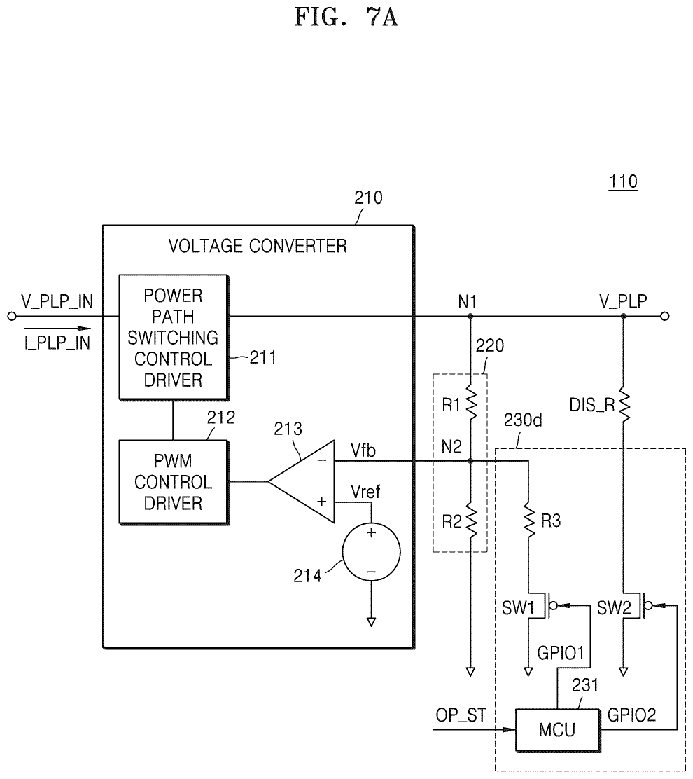

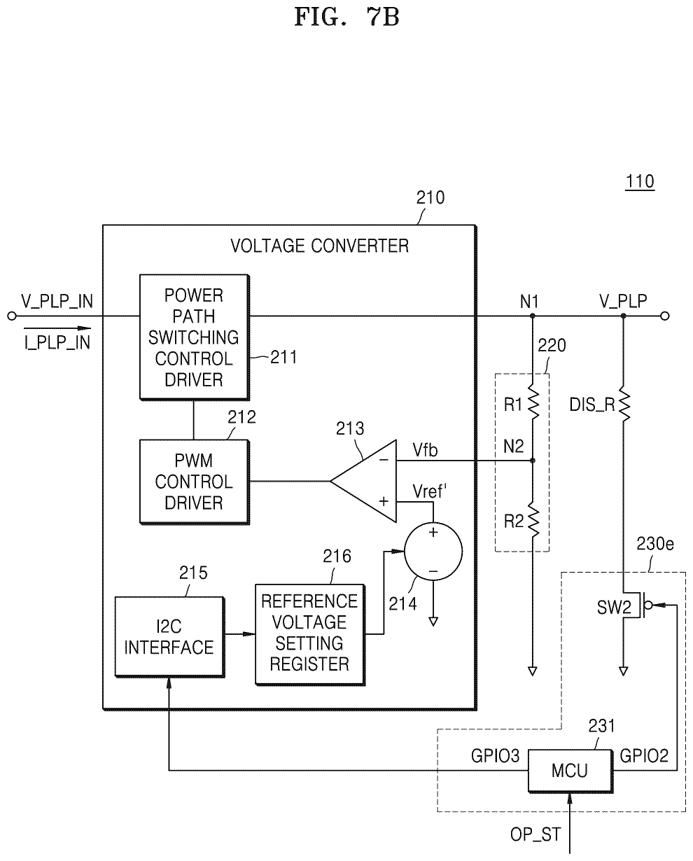

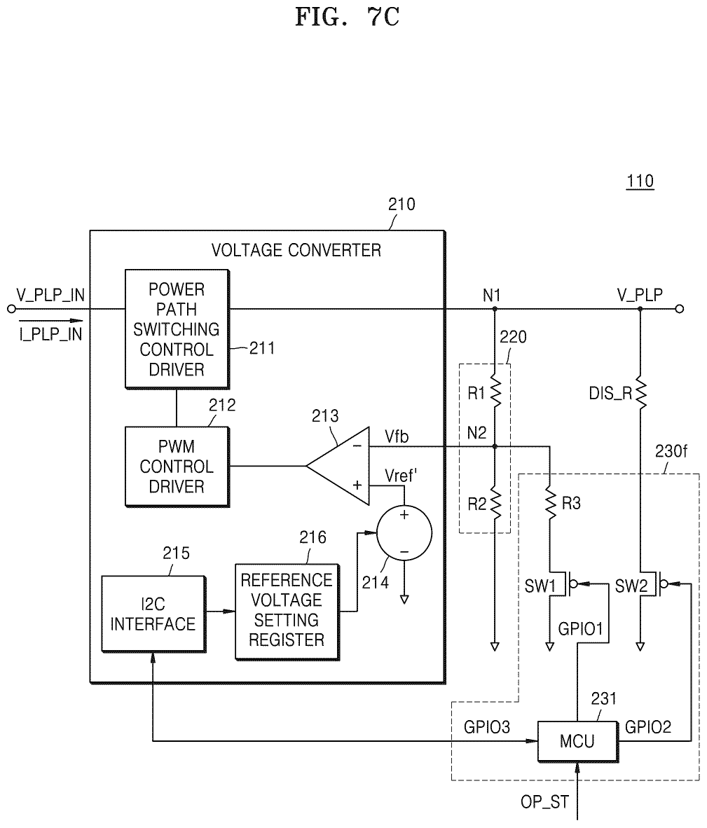

FIGS. 7A, 7B, and 7C are diagrams illustrating respective PLP power managers 110 according to example embodiments.

Referring to FIGS. 3, 5, 7A, 7B, and 7C, the PLP power manager 110 may control the PLP charging voltage (e.g., the PLP voltage V_PLP) to be charged to the first voltage level V1 during the first charge time CHG1 in a normal state and discharged from the first voltage level V1 to the second voltage level V2 during the first discharge time DCHG1. In addition, the PLP power manager 110 may control the PLP charging voltage to be charged to the third voltage level V3 from the fourth voltage level V4 during the second charge time CHG2 and discharged from the third voltage level V3 to the fourth voltage level V4 during the second discharge time DCHG2. In this case, the first charge time CHG1 is greater (or longer) than the second charge time CHG2, the first discharge time DCHG1 is less (or shorter) than the second discharge time DCHG2, the first voltage level V1 is higher than the third voltage level V3, and the second voltage level V2 is higher than the fourth voltage level V4. The voltage converter 210, the feedback voltage divider 220, and the discharge load resistor DIS_R of each of FIGS. 7A, 7B, and 7C are the same as described above.

Referring to FIG. 7A, for example, the PLP power manager 110 may include a PLP voltage regulator 230d, which may perform a first operation and a second operation. The PLP voltage regulator 230d may include a third resistor R3, a first switch SW1, a second switch SW2, and a controller 231. The third resistor R3 and the first switch SW1 are the same as described above with reference to FIG. 2. The second switch SW2 is the same as described above with reference to FIG. 4. The controller 231 is as described above with reference to FIGS. 2 and 4.

Referring to FIG. 7B, for example, the PLP power manager 110 may include a PLP voltage regulator 230e, which may perform a second operation and a third operation. The PLP voltage regulator 230e may include a second switch SW2 and a controller 231. The voltage converter 210 may further include an I2C interface 215 and a reference voltage setting register 216. The controller 231 is as described above with reference to FIGS. 4 and 6. The I2C interface 215 and the reference voltage setting register 216 are the same as the I2C interface 215 and the reference voltage setting register 216 described above with reference to FIG. 6.

Referring to FIG. 7C, for example, the PLP power manager 110 may include a PLP voltage regulator 230f, which may perform a first operation, a second operation and a third operation. The PLP voltage regulator 230f may include a third resistor R3, a first switch SW1, a second switch SW2, a controller 231. The voltage converter 216 may further include I2C interface 215 and the a reference voltage setting register 216. The controller 231 is the same as described above with reference to FIGS. 2, 4, and 6. The I2C interface 215 and the reference voltage setting register 216 are the same as the I2C interface 215 and the reference voltage setting register 216 described above with reference to FIG. 6.

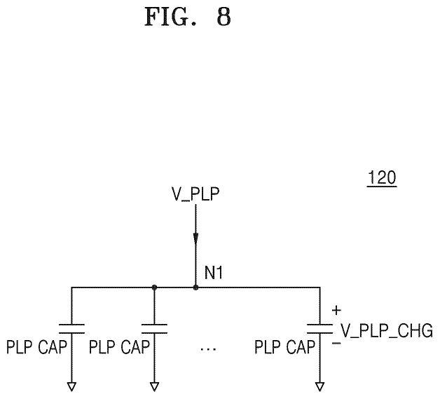

FIG. 8 is a circuit diagram of an auxiliary power supply 120 according to an example embodiment.

Referring to FIG. 8, the auxiliary power supply 120 may include one or more PLP capacitors PLP CAP. For example, at least two PLP capacitors PLP CAP may be connected in parallel with each other. A first terminal of each PLP capacitor PLP CAP may be connected to a first node N1, and a second terminal of each PLP capacitor PLP CAP may be connected to the ground. The PLP voltage V_PLP may be generated at the first node N1. When the PLP voltage V_PLP is applied to the first node N1, each PLP capacitor PLP CAP may charge the PLP charging voltage V_PLP_CHG. The PLP charging voltage V_PLP_CHG may be referred to as a PLP capacitor voltage. For example, the PLP charging voltage V_PLP_CHG of each PLP capacitor PLP CAP may have the voltage level of the PLP voltage V_PLP. The PLP capacitor include various dielectric materials, and in this regard may be classified as an electrolytic capacitor, a tantalum capacitor, a film capacitor, a ceramic capacitor, etc. The charging operation of each of the PLP capacitors PLP CAP may be repeatedly performed at a predetermined period. For example, when the voltage level of the PLP charging voltage V_PLP_CHG reaches the first voltage level V1 in a normal state, charging may be stopped. When charging is stopped, a natural discharge phenomenon in which charges are gradually discharged from the PLP capacitors PLP CAP may occur, and accordingly, a voltage level of the PLP charging voltage V_PLP_CHG may be gradually reduced. As the natural discharge phenomenon occurs, the voltage level of the PLP charging voltage V_PLP_CHG may reach the second voltage level V2 lower than the first voltage level V1. For example, after the voltage level of the PLP charging voltage V_PLP_CHG reaches the third voltage level V3 in an idle state, as a natural discharge phenomenon occurs, the voltage level of the PLP charging voltage V_PLP_CHG may reach the fourth voltage level V4 lower than the third voltage level V3.

The electrical energy stored in the auxiliary power supply 120 may be calculated according to [Equation 4] below.

$${E}_{c} = \frac{1}{2} {CV}^{2} \qquad [ Equation 4 ]$$

In this case, E_{c} is the electrical energy stored in the auxiliary power supply 120, C is the equivalent capacitance of the auxiliary power supply 120, and V is the voltage level of the PLP charging voltage V_PLP_CHG. The capacitance of the auxiliary power supply 120 may indicate the equivalent capacitance of all PLP capacitors PLP CAP included in the auxiliary power supply 120.

FIG. 9 is a diagram for explaining discharge paths according to an example embodiment.

Referring to FIG. 9, in a normal state of the storage device 100, a discharge load resistor DIS_R, a second switch SW2, and the ground may be electrically connected. In a normal state, a discharge current may be generated as a PLP charging voltage charged in the PLP capacitor PLP CAP is discharged, and thus the discharge current may flow through a first discharge path DP1. In addition, a weak leakage current may flow through a second discharge path DP2. Therefore, in the normal state of the storage device 100, the PLP capacitor PLP CAP may be discharged by the discharge current flowing through the first discharge path DP1 and the weak leakage current flowing through the second discharge path DP2.

In an idle state of the storage device 100, the electrical connection between the discharge load resistor DIS_R, the second switch SW2, and the ground may be cut off as the second switch SW2 is opened. In the idle state, a discharge current as a result of discharging the PLP charging voltage may not flow along the first discharge path DP1. The weak leakage current may flow through the second discharge path DP2. Therefore, in the idle state of the storage device 100, the PLP capacitor PLP CAP may be discharged by the weak leakage current flowing through the second discharge path DP2, but not by the discharge current corresponding to the first discharge path DP1. Accordingly, the time discharged in the idle state may be longer than the time discharged in the normal state.

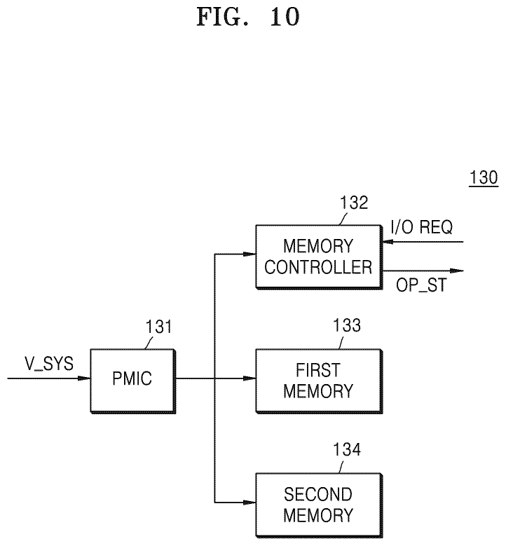

FIG. 10 is a block diagram of a storage system 130 according to an example embodiment.

Referring to FIG. 10, the storage system 130 may include a power management circuit 131, a memory controller 132, a first memory 133, and a second memory 134.

The power management circuit 131 may receive a system voltage V_SYS, generate output voltages suitable for operations of each of the first memory 133 and the second memory 134 by using the memory controller 132 and the system voltage V_SYS, and provide the output voltages to the memory controller 132, the first memory 133, and the second memory 134. For example, the power management circuit 131 may be implemented as a power management integrated circuit (PMIC).

The memory controller 132 may output an operating state signal OP_ST based on an input/output request signal I/O REQ that may be received from a host. For example, when the memory controller 132 receives an input/output request signal I/O REQ, the memory controller 132 may determine the operation state of the storage device 100 as a normal state. The absence of the input/output request signal I/O REQ may indicate that there is no internal I/O communication between the memory controller 132 and the host. For example, when the memory controller 132 does not receive the input/output request signal I/O REQ for a certain period of time, the memory controller 132 may determine the operation state of the storage device 100 as an idle state. The memory controller 132 may control operations of each of the first memory 133 and the second memory 134 such as data read, write, and erase. For example, when an SPO event occurs, the memory controller 132 may control the first memory 133 and the second memory 134 to perform a filtering operation in a filtering mode or a dump operation in a dump mode based on the system voltage V_SYS provided by the PLP power manager 110. In some example embodiments, the memory controller 132 may include a controller 231 implemented as an MCU.

The first memory 133 and the second memory 134 may be different types of memories, respectively. For example, the first memory 133 may be a volatile memory and the second memory 134 may be a nonvolatile memory. For example, the first memory 133 may include at least one of static random access memory (SRAM) and dynamic RAM (DRAM). The second memory 134 may include at least one of flash memory, phase change RAM (PRAM), ferroelectric RAM (FRAM), and magnetic RAM (MRAM). One of the first memory 133 and the second memory 134 may be a cache memory and the other may be a main memory. For example, the first memory 133 may be a cache memory and the second memory 134 may be a main memory. When the first memory 133 is DRAM and the second memory 134 is NAND flash memory, when the storage system 130 operates in a dump mode, the memory controller 132 may control the first memory 133 and the second memory 134 to back up data stored in the first memory 133 to the second memory 134. In an example embodiment, the storage device 100 may be an SSD depending on the type of main memory. For example, when DRAM is used as a cache memory in the first memory 133 and NAND flash memory is used as a main memory in the second memory 134, the storage device 100 may be an SSD device. However, example embodiments are not limited to the storage device 100 being an SSD.

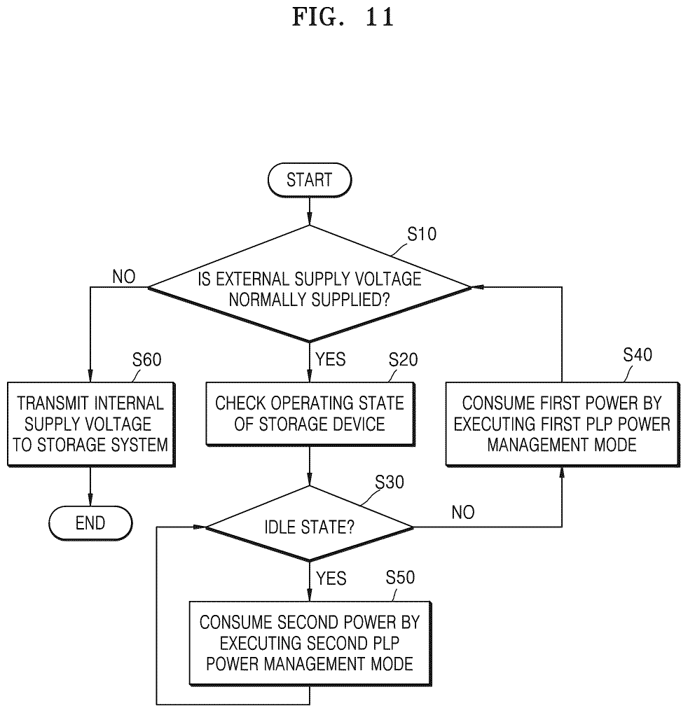

FIG. 11 is a flowchart illustrating a method of operating a PLP power management device, according to an example embodiment.

Referring to FIG. 11, the PLP power management device may correspond to the PLP power manager 110 of FIG. 1.

First, the PLP power management device determines whether a storage device is normally supplied with an external supply voltage (S10). Referring to FIG. 1, for example, the PLP power manager 110 may monitor the voltage level of the external supply voltage V_EXT. In an example embodiment, whether the external supply voltage is normally supplied to the storage device may indicate whether the storage device is linked up.

When the external supply voltage is normally supplied (yes in S10), the PLP power management device checks the operating state of the storage device (S20). Referring to FIG. 1, for example, the PLP power manager 110 may receive an operation state signal OP_ST from the storage system 130 and check the operation state of the storage device 100 from the operation state signal OP_ST.

The PLP power management device checks whether the operating state of the storage device is an idle state (S30).

When the operating state of the storage device is a normal state (no in S30), the PLP power management device consumes first power by executing the first PLP power management mode (S40). For example, the PLP power management device may consume first power by charging and discharging the PLP charging voltage of the PLP capacitor based on the external supply voltage in a normal state.

When the operating state of the storage device is idle (yes in S30), the PLP power management device consumes second power by executing a second PLP power management mode (S50). For example, the PLP power management device may consume second power by charging and discharging the PLP charging voltage of the PLP capacitor based on the external supply voltage in an idle state. The second power may be less than the first power.

When the external supply voltage is abnormally supplied (no in S10), the PLP power management device generates the internal supply voltage (S60). Referring to FIG. 1, for example, the PLP power manager 110 may supply a system voltage V_SYS to the storage system 130 based on the internal supply voltage V_INT provided by the auxiliary power supply 120.

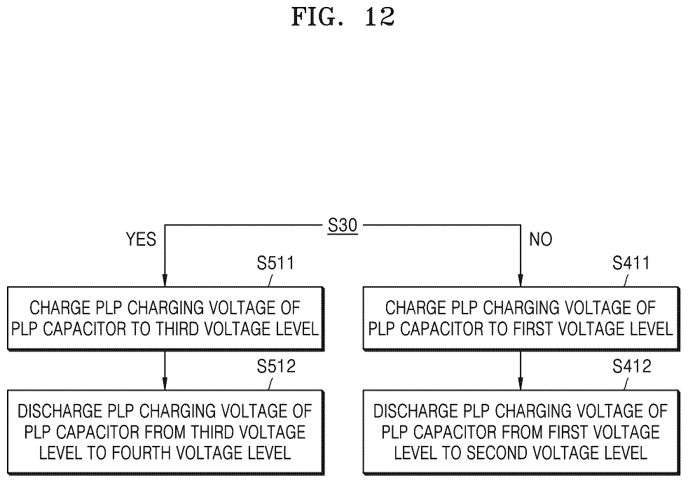

FIGS. 12, 13, and 14 are flowcharts for describing operations S40 and S50 according to an example embodiment.

Referring to FIG. 12, the operation of consuming the first power (S40) may include an operation of charging a PLP charging voltage of a PLP capacitor to a first voltage level (S411), and an operation of discharging the PLP charging voltage of the PLP capacitor from a first voltage level to a second voltage level (S412). The operation of consuming the second power (S50) may include an operation of charging the PLP charging voltage of the PLP capacitor to a third voltage level from a fourth voltage level (S511), and an operation of discharging the PLP charging voltage of the PLP capacitor from the third voltage level to the fourth voltage level (S512). The fourth voltage level may be lower than the second voltage level. Operations S411, S412, S511, and S512 are consistent with the above description with reference to FIG. 3.

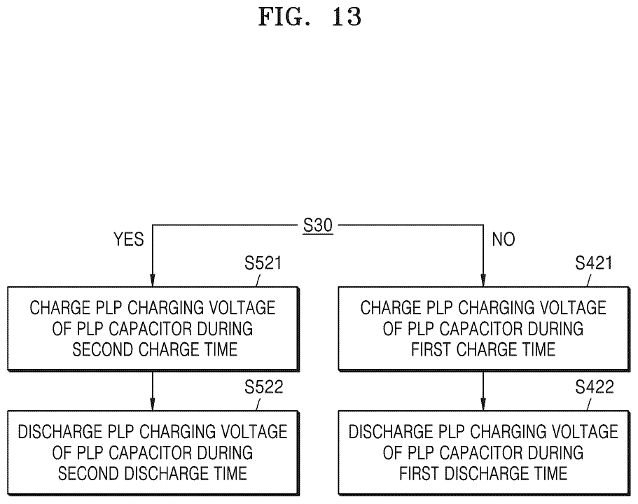

Referring to FIG. 13, the operation of consuming the first power (S40) may include an operation of charging the PLP charging voltage of the PLP capacitor during a first charge time (S421), and an operation of discharging the PLP charging voltage of the PLP capacitor during a first discharge time (S422). The operation of consuming the second power (S50) may include an operation of charging the PLP charging voltage of the PLP capacitor during the second charge time (S521), and an operation of discharging the PLP charging voltage of the PLP capacitor during the second discharge time (S522). The second discharge time may be longer than the first discharge time. Operations S421, S422, S521, and S522 are consistent with the above description with reference to FIG. 5.

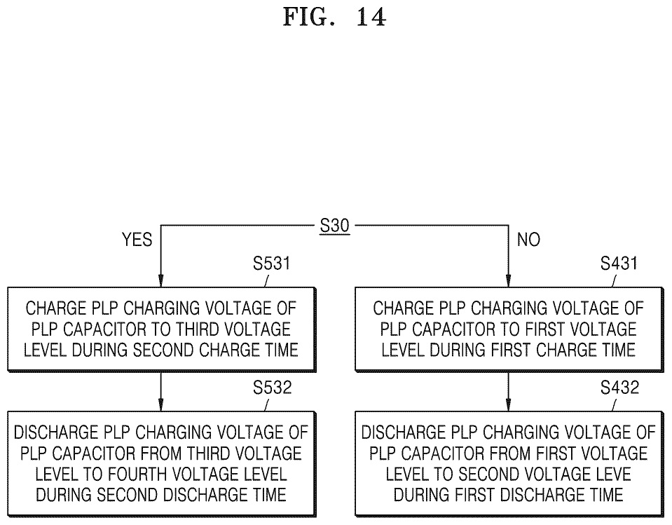

Referring to FIG. 14, the operation of consuming the first power (S40) may include an operation of charging the PLP charging voltage of the PLP capacitor to a first voltage level during a first charge time (S431) and an operation of discharging the PLP charging voltage of the PLP capacitor from the first voltage level to a second voltage level during the first discharge time (S432). The operation of consuming the second power (S350) may include an operation of charging the PLP charging voltage of the PLP capacitor to a third voltage level from a fourth voltage level during the second charge time (S531), and an operation of discharging the PLP charging voltage of the PLP capacitor to the fourth voltage level from the third voltage level during the second discharge time (S532). The first charge time may be greater than the second charge time, the first discharge time may be less than the second discharge time, the first voltage level may be higher than the third voltage level, and the second voltage level may be higher than the fourth voltage level. Operations S431, S432, S531, and S532 are consistent with the above description with reference to FIG. 5.

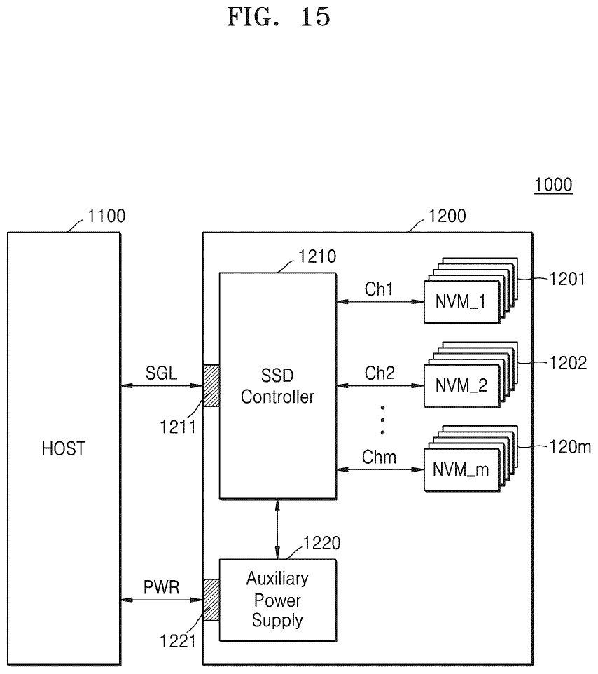

FIG. 15 is a block diagram illustrating an SSD system according to an example embodiment.

Referring to FIG. 15, an SSD system 1000 may include a host 1100 and an SSD 1200.

The SSD 1200 may exchange signals with the host 1100 through a signal connector 1211 and receive power through a power connector 1221. The SSD 1200 may include a plurality of flash memories 1201 to 120m, an SSD controller 1210, and an auxiliary power supply 1220.

The plurality of flash memories 1201 to 120m may be used as storage media of the SSD 1200. A nonvolatile memory device such as PRAM, MRAM, ReRAM, or FRAM may be used as the SSD 1200 in addition to the flash memory. The plurality of flash memories 1201 to 120m may be connected to the SSD controller 1210 through a plurality of channels Ch1 to Chm. One or more flash memories may be connected to one channel. The flash memories connected to one channel may be connected to the same data bus.

The SSD controller 1210 may transmit and receive a signal SGL to and from the host 1100 through the signal connector 1211. Here, the signal SGL may include a command, an address, data, and the like. The SSD controller 1210 may write data to or read data from a corresponding flash memory according to a command of the host 1100.

The auxiliary power supply 1220 may be connected to the host 1100 through the power connector 1221. The auxiliary power supply 1220 may receive power PWR from the host 1100 and charge the power PWR. In addition, the auxiliary power supply 1220 may be located in the SSD 1200 or outside the SSD 1200. For example, the auxiliary power device 1220 may be located on a main board to provide auxiliary power to the SSD 1200.

In some example embodiments, each of the components represented by a block as illustrated in FIGS. 1, 2, 4, 6, 7A, 7B, 7C, 9, 10 and 15 may be implemented as various numbers of hardware, and/or firmware structures that execute respective functions described above, according to example embodiments. For example, at least one of these components may include various hardware components including a digital circuit, a programmable or non-programmable logic device or array, an application specific integrated circuit (ASIC), transistors, capacitors, logic gates, or other circuitry, and may use a direct circuit structure, such as a memory, a processor, a logic circuit, a look-up table, etc., that is configured to execute the respective functions through controls of one or more microprocessors or other control apparatuses. Also, at least one of these components may further include or may be implemented by a processor such as a central processing unit (CPU) that performs the respective functions, a microprocessor, or the like.

While aspects of example embodiments have shown and described, it will be understood that various changes in form and details may be made therein without departing from the spirit and scope of the following claims.

What is claimed is:

1. A storage device comprising:
a memory controller configured to identify an operating state of the storage device based on an input/output request signal provided by a host;
an auxiliary power supply configured to provide an internal supply voltage in a Sudden Power Off (SPO) event; and
a power loss protection (PLP) power manager configured to:
generate a PLP charging voltage based on an external supply voltage;
provide the PLP charging voltage to charge the auxiliary power supply until the PLP charging voltage reaches a first voltage level and discharge the auxiliary power supply until the PLP charging voltage reaches a second voltage level, in a normal state of the storage device; and
provide the PLP charging voltage to charge the auxiliary power supply until the PLP charging voltage reaches a third voltage level and discharge the auxiliary power supply until the PLP charging voltage to a fourth voltage level, in an idle state of the storage device.

2. The storage device of claim 1, wherein the PLP power manager comprises:
a voltage converter configured to convert the external supply voltage to the PLP charging voltage based on a reference voltage and a feedback voltage, and provide the PLP charging voltage to a first node;
a first resistor connected between the first node and a second node, wherein the feedback voltage is provided at the second node;
a second resistor connected between the second node and ground;
a third resistor connected in parallel with the second resistor between the second node and ground;
a first switch connected in series with the third resistor between the second node and ground; and
a discharge load resistor connected between the first node and ground.

3. The storage device of claim 2, wherein a resistance of the second resistor is greater than a composite resistance of the second resistor and the third resistor, and
wherein the first switch is configured to turn off based on the operating state being the idle state.

4. The storage device of claim 1, wherein the PLP power manager comprises:
a voltage converter configured to convert the external supply voltage to the PLP charging voltage based on a reference voltage and a feedback voltage, and provide the PLP charging voltage to a first node;
a first resistor connected between the first node and a second node, wherein the feedback voltage is provided at the second node;
a second resistor connected between the second node and ground;
a discharge load resistor connected between the first node and ground; and
a register configured to control the reference voltage to be reduced based on the operating state being the idle state.

5. The storage device of claim 1, wherein the fourth voltage level is lower than the second voltage level.

6. The storage device of claim 1, wherein a first power consumed in the normal state is greater than a second power consumed in the idle state.

7. A storage device comprising:
a memory controller configured to identify an operating state of the storage device based on an input/output request signal provided by a host,
an auxiliary power supply configured to provide an internal supply voltage in a Sudden Power Off (SPO) event; and
a power loss protection (PLP) power manager configured to:
generate a PLP charging voltage based on an external supply voltage;
provide the PLP charging voltage to charge the auxiliary power supply during a first charge time and discharge the auxiliary power supply a first discharge time, in a normal state of the storage device; and
provide the PLP charging voltage to charge the auxiliary power supply during a second charge time and discharge the auxiliary power supply during a second discharge time, in an idle state of the storage device.

8. The storage device of claim 7, wherein the PLP power manager comprises:
a voltage converter configured to convert the external supply voltage to the PLP charging voltage based on a reference voltage and a feedback voltage, and provide the PLP charging voltage to a first node;
a first resistor connected between the first node and a second node, wherein the feedback voltage is provided at the second node;
a second resistor connected between the second node and ground;
a discharge load resistor connected between the first node and ground; and
a second switch connected in series with the discharge load resistor between the first node and ground, and configured to turn off based on the operating state being the idle state.

9. The storage device of claim 7, wherein the first charge time and the second charge time have a common length.

10. The storage device of claim 7, wherein the second discharge time is longer than the first discharge time.

11. The storage device of claim 7, wherein a first power consumed in the normal state is greater than a second power consumed in the idle state.

12. A power loss protection (PLP) power management device comprising:
a voltage converter configured to convert an external supply voltage to a PLP voltage based on a reference voltage and a feedback voltage, and provide the PLP voltage to a PLP capacitor via a first node;
a feedback voltage divider configured to provide the feedback voltage to the voltage converter based on the PLP voltage;
a discharge load resistor connected in parallel with the PLP capacitor; and
a PLP voltage regulator configured to perform any one or any combination of a first operation to change the feedback voltage, a second operation to block a discharge path between the PLP capacitor and the discharge load resistor, and a third operation to change the reference voltage.

13. The PLP power management device of claim 12, wherein the feedback voltage divider comprises:
a first resistor connected between the first node and a second node, wherein the PLP voltage is provided at the first node and the feedback voltage is provided at the second node; and
a second resistor connected between the second node and ground, and
wherein the PLP voltage regulator comprises:
a controller configured to output a first control signal to control the first operation;
a third resistor connected in parallel with the second resistor between the second node and ground; and
a first switch connected in series with the third resistor between the second node and ground, and configured to operate according to the first control signal.

14. The PLP power management device of claim 13, wherein a resistance of the second resistor is greater than a composite resistance of the second resistor and the third resistor, and
wherein the first switch is configured to turn off based on an operating state being an idle state.

15. The PLP power management device of claim 12, wherein the feedback voltage divider comprises:
a first resistor connected between the first node and a second node, wherein the PLP voltage is provided at the first node and the feedback voltage is provided at the second node; and
a second resistor connected between the second node and ground, and wherein the PLP voltage regulator comprises:
a controller configured to output a second control signal to control the second operation; and
a second switch connected in series with the discharge load resistor between the first node and ground, and configured to turn off according to the second control signal.

16. The PLP power management device of claim 12, wherein the PLP voltage regulator comprises a controller configured to output a third control signal to control the third operation, and
wherein the voltage converter comprises:
a reference voltage source configured to provide the reference voltage;
an amplifier configured to receive the feedback voltage and the reference voltage as inputs, and amplify a difference between the feedback voltage and the reference voltage;
a DC/DC converter power switching circuit configured to rectify the external supply voltage to obtain the PLP voltage;
a register configured to control a voltage level of the reference voltage according to the third control signal; and
an interface configured to communicate with the controller and provide the third control signal to the register.

17. The PLP power management device of claim 16, wherein the DC/DC converter power switching circuit is configured to operate so that the reference voltage and the feedback voltage have a common voltage level.

18. The PLP power management device of claim 12, wherein the feedback voltage divider comprises:
a first resistor connected between the first node and a second node, wherein the PLP voltage is provided at the first node and the feedback voltage is provided at the second node; and
a second resistor connected between the second node and ground,
wherein the PLP voltage regulator comprises:
a controller configured to output a first control signal, a second control signal, and a third control signal;
a third resistor connected in parallel with the second resistor between the second node and ground;
a first switch connected in series with the third resistor between the second node and ground, and configured to operate according to the first control signal; and
a second switch connected in series with the discharge load resistor between the first node and ground, and configured to operate according to the second control signal, and
wherein the voltage converter comprises:
a reference voltage source configured to provide the reference voltage;
an amplifier configured to receive the feedback voltage and the reference voltage as inputs, and amplify a difference between the feedback voltage and the reference voltage;
a DC/DC converter power switching circuit configured to rectify the external supply voltage to obtain the PLP voltage;
a register configured to control a voltage level of the reference voltage according to the third control signal; and
an interface configured to communicate with the controller and provide the third control signal to the register.

19. The PLP power management device of claim 18, wherein a resistance of the second resistor is greater than a composite resistance of the second resistor and the third resistor, and
wherein the first switch is configured to turn off based on an operating state being an idle state.

20. The PLP power management device of claim 18, wherein the DC/DC converter power switching circuit is further configured to operate so that the reference voltage and the feedback voltage have a common voltage level.
